(19) United States
(12) Patent Application Publication
(10) Pub. No.: US 2007/0138997 A1
(43) Pub. Date: Jun. 21, 2007

(54) Motor vehicle charging system with remote temperature compensation

(75) Inventor: Ahmed Lawahmeh, Muncie, IN (US)

Correspondence Address: ICE MILLER LLP, ONE AMERICAN SQUARE, SUITE 3100, INDIANAPOLIS, IN, 46282-0200, US

(73) Assignee: Remy International, Inc.

(21) Appl. No.: 11/303,321

(22) Filed: Dec. 16, 2005

(51) Int. Cl. H02J 7/00

(52) U.S. Cl. 320/104

(57) ABSTRACT

A motor vehicle charging system wherein at least one diode is electrically connected between the rechargeable battery and the voltage regulator. The diode(s) is/are biased to permit current flow from the battery to the voltage regulator. The diode(s) and the battery are arranged so that the diode(s) and the battery experience substantially the same ambient temperature.

### BACKGROUND

A typical motor vehicle charging system serves to keep the motor vehicle battery at or near full charge, and to supply current for the motor vehicle's ignition system and the other electrical systems on the vehicle.

A typical charging system installed in a motor vehicle comprises an alternator and a voltage regulator. A typical alternator comprises a stator, a rotor installed within the stator, and a rectifier bridge. The typical rotor comprises a rotor core surrounded by a field winding. The field winding is surrounded by a pair of interlocking “clawfoot” iron shells. In operation, an electric current is passed through field winding. When field winding is energized, one of the interlocking iron shells becomes a magnetic “north,” and the other interlocking iron shell becomes a magnetic “south.” The interlocking nature of the shells results in a plurality of alternating north poles and south poles.

The stator typically comprises a stationary steel core holding stator windings. The stator windings usually (but not always) consist of three individual sets of windings connected in a delta or wye configuration. As the rotor is rotated within the stator, the rotating alternating north and south poles induce an alternating current in stator windings. The rectifier bridge is electrically connected to the stator windings. The rectifier bridge converts the alternating current produced by stator windings into direct current that is useable to charge a battery and/or to supply current for the motor vehicle's ignition system and the other electrical systems on the vehicle.

A motor vehicle charging system voltage regulator typically is installed in, on, or near the alternator. The voltage regulator is a circuit that senses the output voltage from the alternator and compares the sensed output voltage to a reference voltage called the “set point.” If the voltage regulator detects that the output voltage is too low to charge the battery or to supply other electric loads, the voltage regulator will supply current to field winding. The increased current enhances the strength of the rotor's magnetic field, thereby increasing the output voltage from the alternator. Likewise, if the voltage regulator detects that the output voltage is too high, it will reduce the current supplied to field winding. The reduced current weakens the rotor's magnetic field, thereby decreasing the output voltage put from the alternator. By constantly adjusting the field current, an average output voltage that is required to meet the demands of the battery and vehicle's electrical system is achieved.

The characteristics of a lead-acid battery of the type used in motor vehicle application vary with temperature. In particular, the battery's ability to accept a charge is dependent on ambient temperature. The voltage required to effectively charge the battery varies inversely with the battery's ambient temperature. Accordingly, the output voltage at the rectifier must be higher when the battery's ambient temperature is lower, or else the battery may not fully recharge. Thus, the voltage regulator must supply more current to the field winding when the battery's ambient temperature is lower, to produce the higher output voltage at the rectifier. Likewise, the output voltage at the rectifier must be lower when the battery's ambient temperature is higher, or else the battery may become overcharged and boil over. Thus, the voltage regulator must supply less current to the field winding when the battery's ambient temperature is higher, to produce the lower output voltage at the rectifier. The voltage regulator's set point must adjust according to the battery's ambient temperatures

Many voltage regulators are adapted with temperature sensitive set points. However, a problem arises when the ambient temperature at the voltage regulator is different from the ambient temperature at the battery. This frequently is the case in truck or other heavy duty applications, where the battery or batteries is/are not installed in the vicinity of the voltage regulator. Accordingly, the ambient temperature at the battery can be significantly different from the ambient temperature at the voltage regulator. If the voltage regulator is adjusting the set point according to its ambient temperature, undercharging or overcharging of the battery may result.

For the foregoing reasons, it is desired to provide a motor vehicle charging system wherein the voltage temperature compensation is remote from the alternator. According to the desired system the ambient temperature experienced by the voltage temperature compensation mechanism will be consistent with the ambient temperature experienced by the motor vehicle battery.

### SUMMARY

In an embodiment, the present invention comprises a motor vehicle charging system. The motor vehicle charging system of this embodiment comprises a voltage regulator, a rechargeable battery, and at least one diode electrically connected between the rechargeable battery and the voltage regulator. The at least one diode is biased to permit current flow from the rechargeable battery to the voltage regulator. The at least one diode and the rechargeable battery are arranged such that the at least one diode and the battery experience substantially the same ambient temperature.

In an embodiment, the present invention comprises a motor vehicle charging system. The motor vehicle charging system of this embodiment comprises an alternator, battery, voltage regulator, and diode. The alternator comprising a stator and a rotor. The rotor comprises at least one electrically conductive field winding. The stator comprises at least one electrically conductive stator winding. The rotor is rotatably positioned within the stator such that when a field current flows through the at least one electrically conductive field winding while the rotor rotates within the stator, an induced current is caused to flow in the stator winding. The battery and the alternator are electrically interconnected such that the induced current induced flowing from the stator winding charges the battery. The voltage regulator is electrically interconnected with the alternator such that an output voltage of the alternator is sensed by the voltage regulator, wherein if the voltage regulator senses a changes in the output voltage of the alternator, the voltage regulator is operable to change the field current in response to such change in the output voltage. The at least one diode is electrically connected between the battery and the voltage regulator. The at least one diode and the battery arranged such that the at least one diode and the battery experience substantially the same ambient temperature.

### BRIEF DESCRIPTION OF THE DRAWINGS

The features and advantages of this invention, and the manner of attaining them, will be more apparent and better understood by reference to the following descriptions of embodiments of the invention, taken in conjunction with the accompanying drawings, wherein:

FIG. 1 shows a schematic of a motor vehicle charging system according to an embodiment of the present invention; and

FIG. 2 shows a graph showing the relationship between battery charge voltage and battery temperature experienced according to an embodiment of the present invention.

### DESCRIPTION

For the purposes of promoting an understanding of the principles of the present inventions, reference will now be made to the embodiments illustrated in the drawings, and specific language will be used to describe the same. It will nevertheless be understood that no limitation of the scope of these inventions is thereby intended.

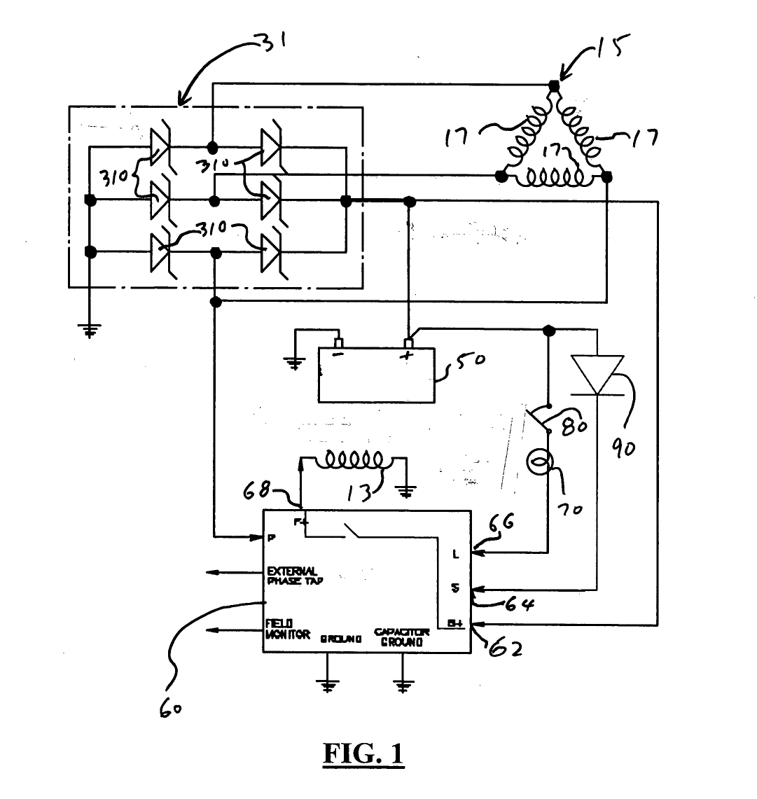

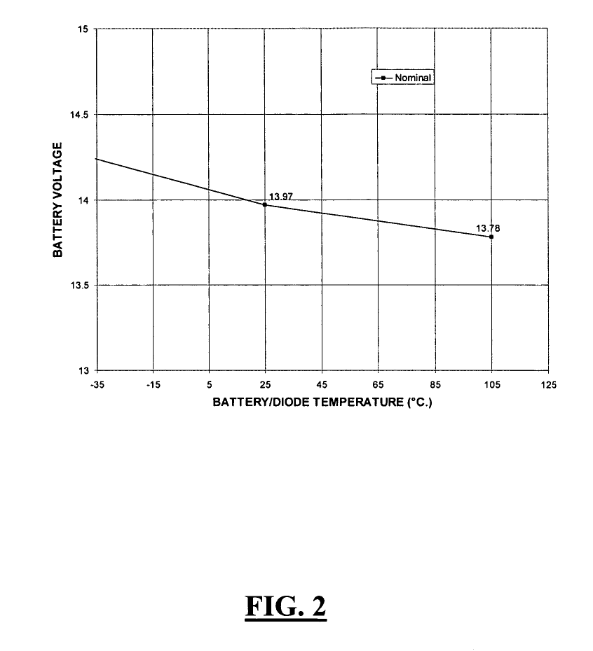

FIG. 1 shows a schematic of an motor vehicle charging system according to an embodiment of the present invention. The embodiment of the present invention shown in FIG. 1 comprises field winding 13, stator 15, bridge rectifier 31, battery 50, voltage regulator 60, warning lamp 70, ignition switch 80 (shown open in FIG. 1), and diode circuit 90. Stator 15 comprises three stator windings 17, connected in delta fashion. Bridge rectifier 31 comprises six diodes 310. Voltage regulator 60 comprises terminal 62, terminal 64, terminal 66, and terminal 68. All items are electrically interconnected as shown in FIG. 2.

Diode circuit 90 comprises one or more diodes electrically connected between the positive terminal of the battery and the external sense terminal 64 of voltage regulator 60. Diode 90 is installed in the motor vehicle near battery 50, so that diode circuit 90 experiences substantially the same ambient temperature as battery 50. Diodes are known to be sensitive to temperature. The voltage drop across diode circuit 90 decreases with higher temperature, and increases with lower temperature.

In operation, the voltage regulator's nominal voltage set point is adapted to compensate for the voltage drop across diode circuit 90 at a predetermined reference temperature. Accordingly, the voltage sensed at terminal 64 at this reference temperature results in the desired voltage output from bridge rectifier 31.

As the temperature at battery 50 and diode circuit 90 increases, the voltage drop across diode circuit 90 will decrease. Accordingly, the voltage sensed at terminal 64 will increase. When voltage regulator 60 detects the increased voltage, it will decrease the current supplied to field winding 13. The decreased current supplied to field winding 13 decreases the output voltage from bridge rectifier 31, causing the voltage delivered to battery 50 to decrease to prevent over-charging the battery.

As the temperature at battery 50 and diode circuit 90 decreases, the voltage drop across diode circuit 90 will increase. Accordingly, the voltage sensed at terminal 64 will decrease. When voltage regulator 60 detects the decreased voltage, it will increase the current supplied to field winding 13. The increased current supplied to field winding 13 increases the output voltage from bridge rectifier 31, causing the voltage at battery 50 to increase for adequate charging.

Shown in FIG. 2 is a graph showing an exemplary relationship between battery charge voltage and battery temperature. The voltage/temperature relationship shown in FIG. 2 were achieved using an implementation of an embodiment of the present invention comprising a Delco-Remy® model 36si alternator with a 14.0V flat T-com voltage regulator model 433VR. In this implementation, a type 10A4 general purpose 10 amp diode was electrically connected between the positive terminal of a standard 12-volt lead-acid battery and the external sense terminal of the voltage regulator. The diode and battery were arranged such that the diode and battery experienced substantially the same ambient temperature.

Diode circuit 90 may comprise any individual electronic component or combination of electronic components that produce a voltage/temperature relationship desired by a practitioner any of the embodiments of the present inventions. Accordingly, the voltage/temperature relationship shown in FIG. 2 is merely exemplary and does not limit the scope of the present inventions in any respect.

While this invention has been described as having a preferred design, the present invention can be further modified within the scope and spirit of this disclosure. This application is therefore intended to cover any variations, uses, or adaptations of the invention using its general principles. Each such implementation falls within the scope of the present invention as disclosed herein and in the appended claims. Furthermore, this application is intended to cover such departures from the present disclosure as come within known or customary practice in the art to which this invention pertains and which fall within the limits of the appended claims.

1. A motor vehicle charging system comprising:
a voltage regulator;
a rechargeable battery; and
at least one diode electrically connected between said rechargeable battery and said rechargeable battery and said voltage regulator, said at least one diode biased to permit current flow from said rechargeable battery to said voltage regulator, said at least one diode and said rechargeable battery arranged such that said at least one diode and said rechargeable battery experience substantially the same ambient temperature.

2. The motor vehicle charging system of claim 1, wherein said voltage regulator and said a rechargeable battery experience different ambient temperatures.

3. A motor vehicle charging system comprising:
an alternator, said alternator comprising a stator and a rotor, said rotor comprising at least one electrically conductive field winding, said stator comprising at least one electrically conductive stator winding, wherein said rotor is rotatably positioned within said stator such that when a field current flows through said at least one electrically conductive field winding while said rotor rotates within said stator, an induced current is caused to flow in said stator winding;
a battery, said battery and said alternator electrically interconnected such that said induced current flowing from said stator winding charges said battery;
a voltage regulator, said voltage regulator electrically interconnected with said alternator such that an output voltage of said alternator is sensed by said voltage regulator, wherein if said voltage regulator senses a changes in said output voltage of said alternator, said voltage regulator is operable to change said field current in response to such change in said output voltage; and
at least one diode electrically connected between said battery and said voltage regulator, said at least one diode and said battery arranged such that said at least one diode and said battery experience substantially the same ambient temperature, wherein said ambient temperature of said diode affects the extent to which said voltage regulator changes said field current.
